(19) United States
(12) Patent Application Publication
(10) Pub. No.: US 2009/0027202 A1
(43) Pub. Date: Jan. 29, 2009

(54) RFID SYSTEM WITH INTEGRATED SWITCHED ANTENNA ARRAY AND MULTIPLEXER ELECTRONICS

(75) Inventors: Richard L. COPELAND, Lake Worth, FL (US); Gary Mark SHAFER, Boca Raton, FL (US)

Correspondence Address: Christopher & Weisberg, P.A., 200 East Las Olas Boulevard, Suite 2040, Fort Lauderdale, FL, 33301, US

(73) Assignee: SENSORMATIC ELECTRONICS CORPORATION, Boca Raton, FL (US)

(21) Appl. No.: 11/829,315

(22) Filed: Jul. 27, 2007

(51) Int. Cl. H04B 7/00

(52) U.S. Cl. 340/572.1

(57) ABSTRACT

An RFID detection system for determining the location of tagged items within an interrogation zone. The system includes one or more printed circuit boards coupled to each other and placed within a region of the interrogation zone. Each printed circuit board contains an antenna array having one or more antennas where each antenna detects the presence of one or more tagged items within a specific read zone in the region. The printed circuit board also contains a multiplexer coupled to the antenna array, where the antenna array and the multiplexer are provided on a substrate. Upon an interrogation request from an RFID reader, a specific antenna can be activated and selected by the multiplexer and tagged items within the antenna's read zone are interrogated. RF signals containing RF identification information are then transmitted back to the RFID reader where a host computer interprets the signals and determines the location of the identified tagged items.

### CROSS-REFERENCE TO RELATED APPLICATION

n/a.

### STATEMENT REGARDING FEDERALLY SPONSORED RESEARCH OR DEVELOPMENT

n/a

### FIELD OF THE INVENTION

The present invention relates to RFID systems and more specifically to a method and system for identifying the location of tagged items in a defined area via the use of multiplexer electronics and an antenna array integrated on the same substrate.

### BACKGROUND OF THE INVENTION

RFID systems are used in many different applications including for example, in retail environments to obtain information relating to items tagged with RFID identifiers. For example, an RFID tag can be attached or integrated within a product or product packaging. Using an RFID interrogator (also referred to herein as an “RFID reader”), which may be a fixed, portable or handheld device, RFID tags within the interrogation zone of the interrogator receive and respond to radio frequency (“RF”) signals to provide information regarding the item associated with the RFID tag, such as the identity of the item and its relative location in the interrogation zone.

In addition, certain RFID applications use a reader to connect to multiple antennas through a multiplexer (“MUX”). For example, in a retail environment using an RFID system to track inventory, it is well known to provide numerous read points that each include the use of RF multiplexers and numerous cables to connect to each read point. In this context, the MUX routes RFID signals, i.e., RF signals, to multiple antennas based on digital logic inputs from a controller. The MUX and the antennas coupled to the MUX are typically used to extend the range of a reader to be able to send commands and/or data to tags and to receive backscatter signals containing responses and/or data from the tags.

However, present RFID systems include numerous wires and cables that connect the MUX and the MUX electronics to the antenna arrays since the MUX and corresponding MUX electronics are housed in a unit separate from the unit housing the antennas. Further, each MUX unit is connected, via another cable, to the RFID reader. The result is a myriad of cables, antennas and multiplexers, often impractical for item location identification in limited spaces such as CD or DVD shelves at retail stores. In addition to creating an unmanageable network of antennas, multiplexers and cables, the cost of all of this hardware is often prohibitive. The result is that facility operators such as retailers and warehouse operators do not implement RFID systems.

It is therefore desirable to have a method and system that eliminates cables and wires in an RFID system by providing an integrated arrangement where the MUX, MUX electronics and the antenna arrays are situated on the same physical substrate.

### SUMMARY OF THE INVENTION

The present invention advantageously provides an RFID detection system for determining the location of tagged items within an interrogation zone. The system includes one or more printed circuit boards coupled to each other and placed unobtrusively within a region of the interrogation zone. Each printed circuit board contains an antenna array having one or more antennas. Each antenna is spaced apart from each other in order to detect the presence of one or more tagged items within a specific read zone within the region. Each printed circuit board also contains a multiplexer and multiplexer electronics coupled to the antenna array. An RF multiplexer can also be coupled to at least one printed circuit board.

Upon an interrogation request from an RFID reader, the RF multiplexer selects and activates a specific antenna array. The multiplexer on the printed circuit board containing the selected antenna array then selects a specific antenna from the array. The selected antenna can then interrogate the tagged items within the antenna's specific read zone. RF signals containing information about the identified tagged items are then transmitted back to the RFID reader where a host computer interprets the signals and determines the location of the identified tagged items.

In one embodiment, a device for use in an RFID detection system is provided. The device includes an antenna array having one or more antennas for detecting the presence of one or more tagged items in an interrogation zone, a multiplexer coupled to the antenna array, where the antenna array and the multiplexer are provided on a substrate, and electronics for facilitating communication between the antenna array and the multiplexer.

In another embodiment, an RFID inventory system is provided. The system includes one or more devices for determining the existence of tagged items in an interrogation zone. Each device includes an antenna array having one or more antennas, where each antenna detects the presence of one or more tagged items within a specific region of the interrogation zone. The device also includes a multiplexer coupled to the antenna array, where the antenna array and the multiplexer are provided on a substrate. The device also includes electronics for facilitating communication between the antenna array and the multiplexer. The system also includes an RFID reader for receiving RF signals from the one or more devices, where the RF signals include information related to the existence of the one or more tagged items, and a computer for interpreting the RF signals received by the RFID reader.

In yet another embodiment, a shelf reader system for determining the location of tagged items in a predetermined area is provided. The shelf reader system includes one or more devices positioned within the predetermined area where each device includes an antenna array having one or more antennas. Each antenna detects the presence of one or more tagged items within a specific region of the predetermined area. Each device also includes a multiplexer coupled to the antenna array and electronics for facilitating communication between the antenna array and the multiplexer. The antenna array and the multiplexer are provided on a substrate. The shelf reader system also includes an RFID reader for receiving RF signals from the one or more devices. The signals include information related to the presence of the one or more tagged items. A computer then interprets the RF signals received by the RFID reader for determining the location of the identified tagged items.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a system constructed in accordance with the principles of the present invention;

FIG. 2 is a block diagram of an embodiment of the present invention incorporated in a multi-shelf reader application;

FIG. 3 is a block diagram of an embodiment of the present invention incorporated in a DVD inventory application;

FIG. 4 is a perspective view of the application depicted in the block diagram of FIG. 2; and

FIG. 5 is a perspective view of an alternate embodiment of the present invention.

### DETAILED DESCRIPTION OF THE INVENTION

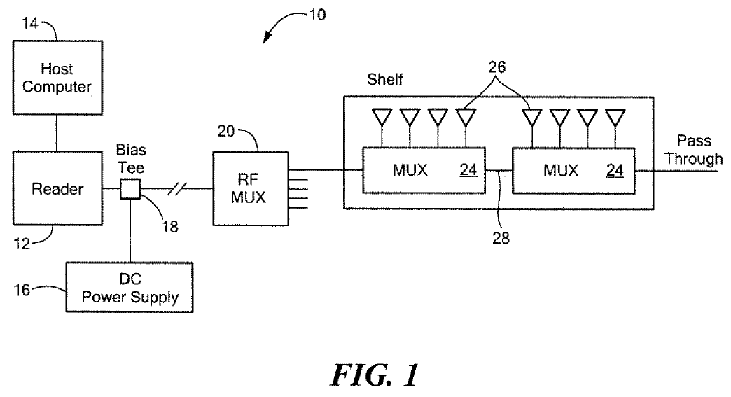

Referring now to the drawing figures in which like reference designators refer to like elements, there is shown in FIG. 1 a diagram of an exemplary system constructed in accordance with the principles of the present invention and designated generally as “10”. System 10 is an RFID surveillance system that includes one or more RFID readers 12 in communication with a host computer 14. Reader 12 exchanges data with host computer 14 as may be necessary, e.g., to identify and/or perform inventory control of tagged items within the interrogation zone. Host computer 14 includes the necessary databases and software to track and maintain the inventory or to determine the location of tagged items in a given interrogation zone. Host computer 14 includes those components, e.g., memory, CPU, I/O, display, etc., to track the communication and hierarchical relationship between the other devices in system 10, e.g., multiplexers (MUXes), tags, and the like. A power supply such as a DC power supply 16 provides power to reader 12 via bias tee 18.

System 10 allows any person or entity using RFID to track, locate, identify, process, filter, or otherwise manage a plurality of tagged items in a given space through RFID communications. This is accomplished by using RFID reader 12 coupled with one or more RFID antennas forming an antenna array 26. System 10 can be implemented in all or a portion of any appropriate location including, for example, a retail store, grocery store, a factory, or a warehouse. These locations may include thousands or even millions of items stored across tens of thousands of square feet.

As used herein, tagged items may each be any component, device, commodity or other product or article operable to be tagged using RFID tags. For example, tagged items may include electronic devices, luggage, groceries, boxes, or various other articles. These tagged items are associated with a plurality of electronic characteristics including, for example, serial number, color, price, manufacturer, and other identifying data using tag information.

The RFID tag affixed to the item is any component operable to communicate radio signals or other wireless communications that include identifying and/or positional information. The RFID tag is typically a small component that may be wired, affixed, or otherwise secured to the item. In certain embodiments, the RFID tag may be secured in such a way that removing it will disable tag or activate some other security feature.

Returning to the embodiment depicted in FIG. 1, RFID reader 12 is coupled to one or more RF MUXes 20, via either a wireless or a hardwired connection. RF MUX 20 includes a microcontroller and logic circuitry to control the operation of RF MUX 20. For example, a storage unit, RF detectors, modulators and switching elements are in electrical communication with the microcontroller. In operation, MUX operating code and data are stored in volatile and/or non-volatile storage areas. Modulators are used to modulate a baseband signal onto an RF carrier for transmission via switching elements. Detectors, samplers and couplers operate together to detect and extract the baseband signal and command and block data from a received RF signal.

RF MUX 20 is coupled to one or more printed circuit boards (“PCBs”) 22. Each physical substrate, e.g. PCB, contains its own PCB MUX 24, associated MUX circuitry, and one or more RF antennas forming an antenna array 26. Each RF antenna is part of an antenna array 26 that is capable of retrieving RF identification information related to each tagged item in the interrogation zone. Advantageously, a particular antenna from the antenna array 26 can be selected by reader 12 via PCB MUX 24 to interrogate one or more items within a specific region (“read zone”) of the interrogation zone. The physical location of the selected antenna can then be determined by its logical address. Thus, system 10 is able to determine not only the identity of a tagged item but also its relative location within the interrogation zone.

RF antenna array 26 includes antennas constructed in accordance with the principles of the present invention that is operable to communicate using RFID communications. For example, the antennas of RF antenna array 26 may be operable to communicate with RFID tags, RFID MUX 20, PCB MUX 24, and RFID reader 12 using any appropriate technique including using wired or wireless communications.

In one embodiment, antenna array 26 can be an array of linearly or circularly polarized patch antennas with a substantially square geometry. Each antenna in array 26 may be separated or spaced away from each other depending upon the tagged product that is stacked in the shelf or other enclosed region. For example, in one scenario, system 10 is used to determine the presence and location of DVDs stacked on a shelf or on multiple shelves. Since DVDs are approximately 13.5 cm wide and the required antenna spacing is about 150 centimeters, a small space or gap is provided between DVDs on the shelf. In general, each antenna corresponds to a specific read zone or region on the shelf so that inventory of specific regions can be obtained and isolated from other nearby regions. In this fashion, the location of tagged items within a larger interrogation zone can be obtained.

Each RF antenna is placed in close proximity to a tagged item in the interrogation zone. In one embodiment, the tagged items are placed directly on a single planar antenna, which is part of antenna array 26. The RFID tags are applied to the items in such a location that each antenna can properly detect the presence of the tag within a specific region. In one example, the PCB 22 containing the antenna array 26 is placed directly upon the bottom surface of a shelf. Tagged items are then placed either directly on each antenna in array 26 or in close proximity to an antenna. When activated, each antenna is capable of receiving tag identification information, which identifies the item to which the RFID tag is affixed.

PCB MUX 24 can select and activate any antenna from array 26 depending upon instructions from reader 12. Upon receipt of instructions from reader 12, RF MUX 20 selects which antenna array 26 on which PCB 22 to activate. Once obtained, RF signals containing identification information are then transmitted back to RFID reader 12. Computer 14 interprets these signals and, according to the logical address of the antenna that obtained the identification information determines where, i.e., in which “read zone”, the tagged item is located in.

Although FIG. 1 depicts two side-by-side PCBs 22 within a shelf, the invention is not limited to this arrangement. One or more PCBs 22 may be incorporated in any arrangement within a given interrogation zone. RF MUX 20 can be either hardwired or in wireless communication with each PCB 22. RF MUX 20 selectively receives RF signals from each PCB 22, whereby the RF signals include identification information from each antenna relating to one or more tagged items. Advantageously, each PCB 22 includes both a PCB MUX 24 and an antenna array 26. The PCB MUX 24 acts as a switch to select a particular antenna from the antenna array 26. Thus, there is no need for cumbersome wires and/or coaxial cables to connect a single and remotely located multiplexer with an antenna array 26 located near the tagged items.

A pass-through port 28 allows reader 12, via RF MUX 20, to not only select any antenna from array 26 on PCB 22, but also from any other antennas located on other PCBs that may be electrically connected to PCB 22 via pass-through port 28. Because pass-through port 28 provides an electrical connection between PCBs 22, reader 12 can detect the presence of additional PCB MUXes 24 since each PCB MUX 24 is located on its own PCB 22. Each PCB MUX 24 appears to reader 12 as a “tag” containing RF identification information. Thus, reader 12 interrogates these “tags”, which are actually MUXes 24, and receives RFID information. As described above, the logical address of the antenna from array 26 that obtained the RFID information about a particular tagged item is known. Computer 14 can then determine the “read zone” of the interrogating antenna and thus the actual location of the tagged item.

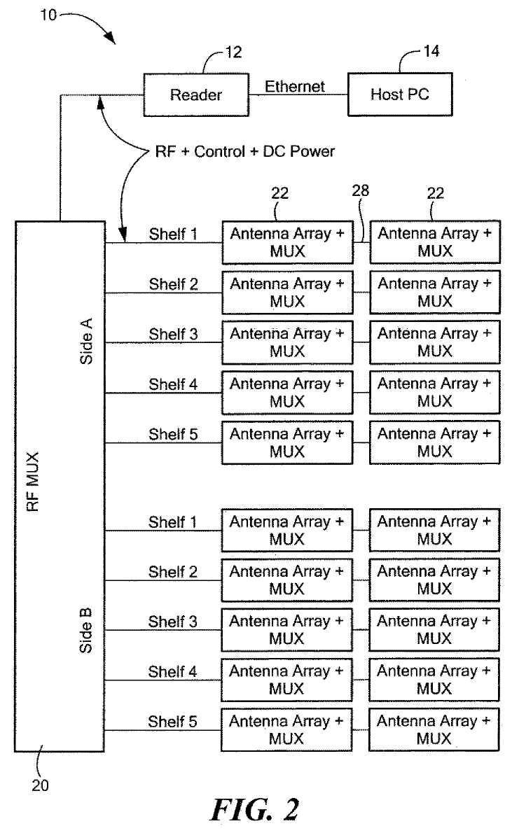

Referring to FIG. 2, a block diagram of a multi-shelf reader application of the present invention is depicted. In this embodiment, system 10 is used to interrogate tagged items situated on a plurality of shelves. Each shelf includes one or more PCBs 22 connected to each other via a pass-through port 28. Pass-through port 28 can be either a hard wired connection between two PCBs 22 or may be a wireless connection. Each PCB 22 includes its own PCB MUX 24 and antenna array 26.

In this embodiment, a DVD rack of five shelves is separated into two sides by a frame or stand. Each shelf is divided into two sides, Side A and Side B. Each shelf side contains two side-by-side PCBs 22. Each PCB 22 is responsible for receiving identification information from tagged DVDs within its read zone. Thus, each shelf is divided into four read zones, two read zones on Side A and two read zones on Side B. In this embodiment, each PCB 22 contains a PCB MUX 24 and an antenna array 26 comprised of four discrete antennas. Because each antenna array 26 has four antennas and each antenna is responsible for obtaining RFID signals from the tagged DVDs within its region, the embodiment in FIG. 2 has eight read zones on each shelf side, or a total of sixteen read zones on each shelf. The five shelves therefore comprise eighty specific read zones.

In the shelf reading application depicted in FIG. 2, instructions are sent from host computer 14 to RFID reader 12 to transmit an interrogation request in order to determine the presence and location of a particular DVD within the interrogation zone. RFID reader 12 can select different antenna arrays 26 on different PCBs 22 to interrogate a specific region. This is accomplished via the RF MUX 20 which acts as a switch to select a particular PCB 22. Once a PCB 22 is selected, the PCB MUX 24 on the selected PCB 22 acts as a switch to activate the antenna array 26. The antennas of each antenna array 26 read a specific region to interrogate each of the tags on items in that region. In this fashion, once the tag corresponding to the desired DVD has been identified, its location can be determined.

For example, the DVD for the movie “XYZ” might be located in a region under the 3^{rd} antenna on the second PCB 22, on Side B of Shelf 4. An RF signal is transmitted back to reader 12 and host computer 14 containing the RFID information identifying this DVD and the logical address of the antenna that interrogated the region where the DVD was situated. Host computer 14 processes this information and determines the actual location of the DVD.

In FIG. 2, each PCB 22 includes its own antenna array 26 and a PCB MUX 24. Because a single PCB 22 can contain a MUX 24 and an antenna array 26, there is a tremendous savings in cost and space since cables and wires that are normally needed to connect each antenna array 26 with a remotely-located MUX are no longer necessary. The embodiment shown in FIG. 2 can be extrapolated to any number of PCBs 22 in any arrangement that can pass information to each other via one or more pass through ports 28.

RFID reader 12 receives information from what it believes are a plurality of RFID tags, where each RFID tag contains identification information about tagged items in the interrogation zone. However, in actuality, some of the tags are really MUXes that have received information from one or more antennas. In other words, the MUXes appear as tags to reader 12. Upon receipt of the return RFID signals, software within computer 14 can determine from which antenna the information was taken. Because the location of each antenna is known, and because each antenna is responsible for reading a tagged items in a specified region, the location of a tagged item or items can be determined.

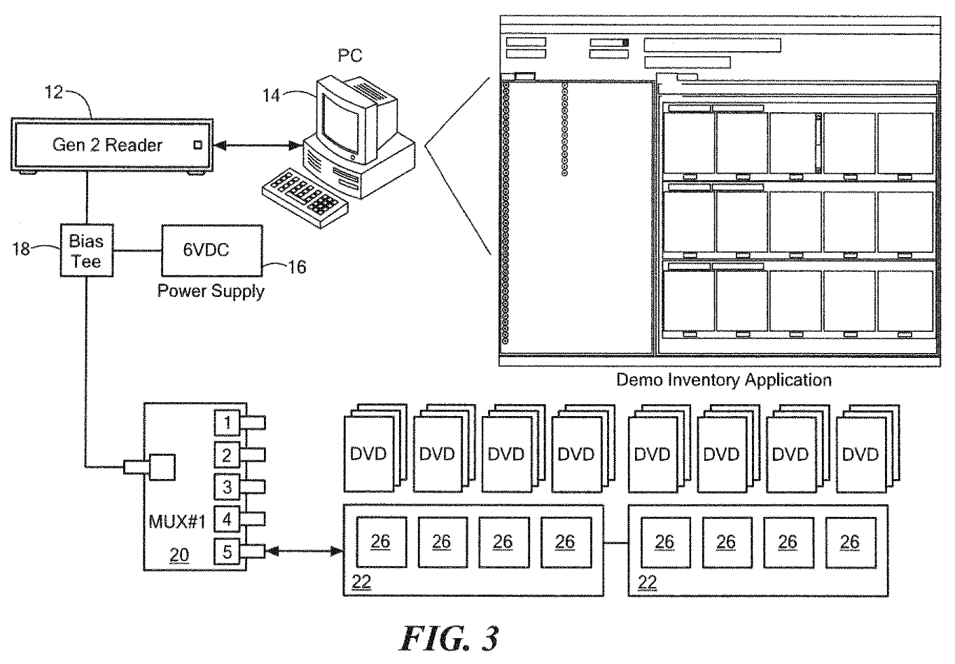

FIG. 3 provides another embodiment of the DVD multiple-shelf reader application. In this scenario, host computer 14 is in the process of updating its inventory related to tagged items in the interrogation zone. One or more DVDs are placed over or near a discrete antenna. Each antenna is part of an antenna array 26 on PCB 22. In this example, two PCBs 22 are side-by-side along a shelf. Each antenna 26 reads and receives identification information from the tag of each tagged DVD within its read zone. PCB MUX 24 (not shown in FIG. 3) is situated on a PCB 22 and controls the antenna array 26 on the PCB 22 by selecting a particular antenna from the array. RF MUX 20 acts as a switch between each of the PCBs 22 by selecting a particular PCB 22 to activate depending upon which region (in this case, Shelf 5) that reader 12 wants to interrogate. Once received, RF MUX 20 passes this information back to reader 12 and computer 14. RF MUX 20 can then select another region by activating another PCB 22 and receive DVD identification information in a similar manner. Upon receipt of this information, computer 14 updates its inventory records to reflect the current location of each DVD within the interrogation zone.

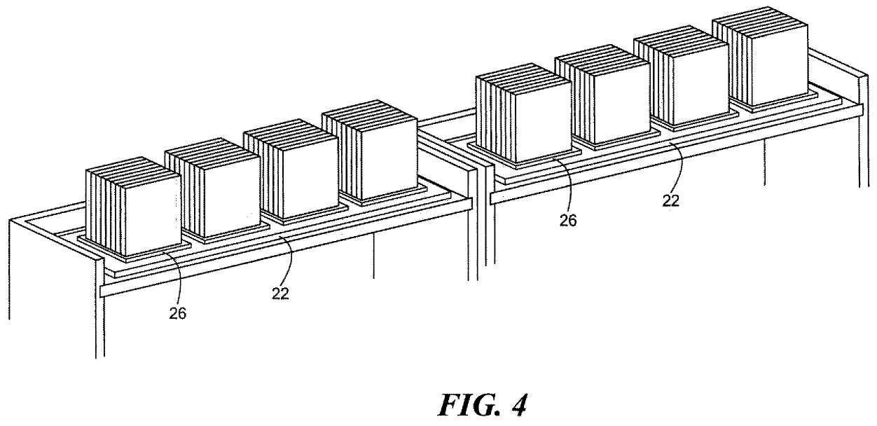

FIG. 4 is a perspective view of the DVD shelf-reader application shown in FIG. 2. Stacks of DVDs are placed over or near a specific antenna, which is part of the antenna array 26 of PCB 22. The side-by-side arrangement of PCBs 22 on each shelf results in an unobtrusive, low-profile and streamlined RFID tagged item-location system. In this embodiment, each PCB 22 contains four discrete antennas. Another PCB 22 is situated next to the first PCB 22 and is connected to the first PCB via a pass through port 28 (not shown). This connection can be either hard-wired or wireless. Each PCB 22 also contains a PCB MUX 24 (not shown), and MUX electronics.

One or more PCBs 22 can be placed along the bottom surface of a shelf or within any storage compartment that holds tagged items. Because each PCB 22 includes an integrated antenna array and MUX 24, there is no need to provide any connecting cables or to provide for additional space to house a remote MUX. RF MUX 20 (not shown) may be electrically coupled to each PCB 22 via either a hard-wired or wireless connection. RF MUX 20 acts as a switch to select and activate the antenna arrays 26 on each PCB 22. RF MUX 20 receives RFID information from the selected antenna array 26 and transmits this information back to RFID reader 12 and computer 14. Each PCB 22 is placed unobtrusively along the upper face of the shelf.

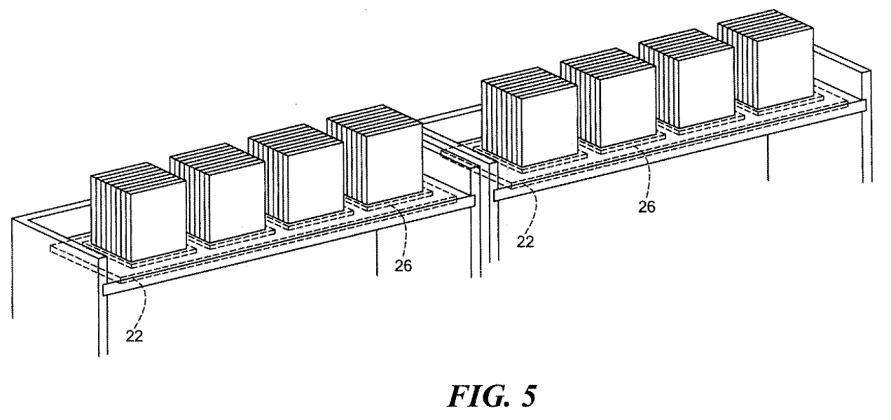

In the embodiment shown in FIG. 5, PCBs 22 form an integral part of the bottom surface of the shelf. In this embodiment, rather than being placed directly on the upper surface of a shelf, each PCB 22 is integrated into the shelf itself. The result is a series of antenna arrays 26 that may be placed inconspicuously within specific regions of an interrogation zone. Each antenna array 26 is integrated with its own multiplexer 24 on a PCB 22 thus obviating the need for any connecting wires coupling the antenna array 26 to its MUX 24.

As shown in FIG. 5, there are no unsightly wires or additional hardware needed to house a remote multiplexer. Multiple PCBs 22 and their antenna arrays 26 can be connected to each other either wirelessly or via a hard wire connection, by a pass through port (not shown), The only other hardware needed is an RFID reader 12, a computer 14 and, if necessary, an RF MUX 20. These devices can be also hidden away from sight. Further, PCBs 22 can be integrated within display cases, shelves, and/or warehouse racks in order to increase storage capacity and eliminate unsightly wires and hardware.

The present invention can be realized in hardware, software, or a combination of hardware and software. An implementation of the method and system of the present invention can be realized in a centralized fashion in one computer system or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A device for use in an RFID detection system, the device comprising:
an antenna array having one or more antennas for detecting the presence of one or more tagged items in an interrogation zone;
a multiplexer coupled to the antenna array, the antenna array and the multiplexer being provided on a substrate; and
electronics for facilitating communication between the antenna array and the multiplexer.

2. The device of claim 1, wherein each antenna of the antenna array interrogates a specific region of the interrogation zone.

3. The device of claim 1, the device further comprising a pass-through port to allow the device to be coupled to additional devices.

4. The device of claim 3, wherein the pass-through port provides a wireless connection between the device and the additional devices.

5. The device of claim 1, wherein the antenna array is comprised of one or more linear polarized patch antennas.

6. The device of claim 1, wherein the antennas of the antenna array are spaced apart from each other according to the distance between groups of tagged items.

7. The device of claim 1, wherein the multiplexer allows for the selection of a particular antenna depending upon commands received from a host computer.

8. The device of claim 1, wherein the substrate is a printed circuit board.

9. An RFID inventory system comprising:
one or more devices for determining the existence of tagged items in an interrogation zone, each device comprising:
an antenna array having one or more antennas, each antenna detecting the presence of one or more tagged items within a specific region of the interrogation zone;
a multiplexer coupled to the antenna array, the antenna array and the multiplexer being provided on a substrate; and
electronics for facilitating communication between the antenna array and the multiplexer;
an RFID reader for receiving RF signals from the one or more devices, the RF signals including information related to the existence of the one or more tagged items; and
a computer for interpreting data corresponding to the RF signals received by the RFID reader.

10. The RFID inventory system of claim 9, further comprising an RF multiplexer coupled to at least one of the devices, wherein the RF multiplexer selects an antenna array to activate upon receipt of an interrogation request from the RFID reader.

11. The RFID inventory system of claim 9, wherein each antenna of the antenna array interrogates a specific region of the interrogation zone.

12. The RFID inventory system of claim 9, the device further comprising a pass-through port to allow the device to be coupled to additional devices.

13. The RFID inventory system of claim 12, wherein the pass-through port provides a wireless connection between the device and the additional devices.

14. The RFID inventory system of claim 9, wherein the antenna array is comprised of one or more linear polarized patch antennas.

15. The RFID inventory system of claim 9, wherein the antennas of the antenna array are spaced apart from each other according to the distance between groups of tagged items.

16. The RFID inventory system of claim 9, wherein the multiplexer allows for the selection of a particular antenna depending upon commands received from the host computer.

17. The inventory system of claim 9, wherein the substrate is a printed circuit board.

18. A shelf reader system for determining the location of tagged items in a predetermined area, the system comprising;
one or more devices positioned within the predetermined area, each device comprising:
an antenna array having one or more antennas, wherein each antenna detects the presence of one or more tagged items within a specific region of the predetermined area;
a multiplexer coupled to the antenna array, the antenna array and the multiplexer being provided on a substrate; and
electronics for facilitating communication between the antenna array and the multiplexer;
an RFID reader for receiving RF signals from the one or more devices, the signals including information related to the presence of the one or more tagged items; and
a computer for interpreting the RF signals received by the RFID reader.

19. The system of claim 18, wherein the antenna array is comprised of one or more linear polarized patch antennas.

20. The system of claim 18, wherein the multiplexer allows for the selection of a particular antenna depending upon commands received from the computer.

21. The system of claim 18, wherein the one or more devices are integrated into a shelf forming a portion of the enclosed space.

22. The system of claim 18, further comprising an RF multiplexer coupled to at least one of the devices, wherein the RF multiplexer selects an antenna array to activate upon receipt of an interrogation request from the RFID reader.

23. The system of claim 18, wherein the substrate is a printed circuit board.
